(19) United States
(12) Patent Application Publication
(10) Pub. No.: US 2016/0316778 A1
(43) Pub. Date: Nov. 3, 2016

(54) LAURIC FAT BASED STRUCTURING AGENTS TO REDUCE SATURATED FAT

(71) Applicant: NESTEC S.A., Vevey (CH)

(72) Inventors: Kornel Nagy, Lausanne (CH); Estelle Pionnier Pineau, Estelle (CH); Laurence Sandoz, Echallens (CH); Jin-Mi Jung, Beauvais (FR); Constantin Bertoli, Konolfingen (CH)

(21) Appl. No.: 15/103,559

(22) PCT Filed: Dec. 11, 2014
(86) PCT No.: PCT/EP2014/077411

§ 371 Date: Jun. 10, 2016

(30) Foreign Application Priority Data
Dec. 13, 2013 (EP) 13197235.8

(51) Int. Cl. A23D 9/00; A23L 23/10; A23G 1/30; C11C 3/02; A23G 3/34; A23G 3/40; A23G 9/32; A23C 19/055; A23G 1/36

(52) U.S. Cl. CPC A23D 9/00; A23C 19/055; A23L 23/10; A23G 1/305; A23G 1/36; A23G 3/343; A23G 3/40; A23G 9/322; A23G 9/327; C11C 3/02; A23V 2002/00

(57) ABSTRACT

The present invention relates to a lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0. Further aspects of the invention are: the structuring agent, a food product comprising the lipid composition, the use of the lipid composition as a structure stabilizer or a moisture barrier in a food product; and a method for preparing the lipid composition.

### TECHNICAL FIELD

The present invention relates generally to lipid compositions. In particular the invention relates to compositions comprising a structuring agent dispersed in edible fat/oil.

### BACKGROUND OF THE INVENTION

Fats are important ingredients in a wide variety of manufactured foods, cosmetics and pharmaceuticals. The physical properties of fats, such as their melting point or texture, affect which applications they are suitable for. There is increasing interest in being able to structure soft fats or liquid fats/oils to make their physical properties more like those of harder, higher-melting fats. For example, structured fats with firm textures can be used in topical delivery of pharmaceutically active liquid fats or fat-soluble medicaments. In food manufacturing, structured soft fats may be used to replace hard fats whilst maintaining many of the hard fats' desired textural properties. This can provide new means to improve the nutritional quality of consumers' diets.

The hardness and the melting profile of a fat are linked to its degree of saturation. Highly saturated fats are generally solid at ambient conditions, e.g. palm fat or any hydrogenated vegetable fat. Fats which are liquid at ambient conditions generally have low levels of saturation, e.g. a sunflower oil.

Fats with a high solid fat content at room temperature are commonly referred to as hard fats. These fats traditionally have a variety of applications in foods, such as in ice cream products, “shortenings” in bakery products, fillings in sandwich biscuits, or as coatings, for example chocolate-like coatings on ice cream or bakery products. Fats with high saturated fatty acid (SFA) content are generally used in these products to impart desired textural and sensorial properties. In frozen confectionery such as ice cream the hard fats create a desirable texture and also serve as a moisture barrier. Such fats may be for example coconut oil, palm oil, palm kernel oil.

However, fats containing high amounts of SFAs are believed to have negative health effects, for example being linked to an enhanced risk for cardiovascular diseases. In recent years, this has led to an increasingly negative consumer perception of saturated fats.

Hydrogenation is a commonly used technique to obtain hard fats from unsaturated liquid fats. Besides the resulting high SFA content, the presence of trans unsaturated fatty acids in partially hydrogenated fats has become an important health issue. Trans fatty acids have been associated with cardiovascular diseases as well as diabetes and some types of cancer such as breast cancer.

Hence it would be desirable to replace high SFA hard fats, or hydrogenated fats containing significant levels of trans fatty acids, by predominantly unsaturated fats having a low solid fat content. However, it is evident that in many applications it is not possible to use a liquid fat instead of a solid fat. Using a liquid fat will dramatically alter physical properties such as texture, melting/flavor release and overall appearance.

One approach is to add an ingredient to the soft fat which creates a structure within the overall composition. Patent WO95/22257 describes fat blends, suitable for food products, comprising diacylglycerols and triacylglycerols. The diacylglycerols predominantly had either two unsaturated fatty acids with at least 16 carbon atoms, or one unsaturated fatty acid with at least 16 carbon atoms together with a saturated fatty acid with between 12 and 24 carbons. Such fat blends could be used to produce fillings which were harder and had lower saturated fat than a commercial filling fat Biscuitine SF™, although they were found to have a reduced flavor release.

For lipid compositions used in frozen confectionery products, the consumer is not willing to compromise on the organoleptic properties of the product in order to reduce consumption of SFA. Taste, texture and overall appearance are such organoleptic properties. In addition, consumers may prefer not to buy products containing hydrogenated fats. Accordingly there is an ongoing need to provide low SFA lipid compositions for frozen confectionery products, having good organoleptic properties.

### SUMMARY OF THE INVENTION

It is an object of the present invention to provide structured lipid compositions for food products that have a low SFA content and good textural and sensorial properties such as good creamy texture.

In a first aspect the invention relates to lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0. In another aspect, the invention relates to the use of the lipid composition of the invention as a moisture barrier in a food product.

In a further aspect, the invention relates to a food product comprising the lipid composition of the invention.

In an additional aspect of the invention it relates to a structuring agent comprising at least 50 wt % of triacylglycerol containing a glycerin skeleton esterified with one type of saturated fatty acid having a chain length of either 10:0, 12:0 or 14:0.

In an additional aspect of the invention it relates to a method for preparing the lipid composition of the invention comprising preparing a structuring agent comprising at least 50 wt % of triacylglycerol containing a glycerin skeleton esterified with one type of saturated fatty acid having a chain length of either 10:0, 12:0 or 14:0; melting the structuring agent; combining the structuring agent with an edible fat to form a mixture; homogenizing the mixture; and cooling the mixture.

### BRIEF DESCRIPTION OF THE FIGURES

FIG. 1 shows the observed pseudomoelcular ion with m/z 656 and the fragmentation pattern of parent ion m/z 656 reflecting the loss of lauric acid. The y axis is the relative abundance of the ions [signal %] and the x axis is the mass-to-charge ratio (m/z).

FIG. 2 shows the confirmation of the elimination of dilaurin by single stage mass spectromerty of the purified structuring agent. The height of the bars is the relative abundance [signal %].

FIG. 3 shows that after melting, cooling to 4° C. or below and keeping at room temperature for a day, high oleic sunflower oil and the mixture of high oleic sunflower oil and coconut oil 7:3 appeared completely liquid.

FIG. 4 shows that after melting, cooling to 4° C. or below and keeping at room temperature for a day, high oleic sunflower oil appeared completely liquid, while all others containing the structuring agent trilaurin/trimyristin remained solidified.

FIG. 5 shows that after melting, cooling to 4° C. or below and keeping at room temperature for a day, the mixture of 15% trilaurin in high oleic sunflower oil remained solidified.

### DETAILED DESCRIPTION OF THE INVENTION

### Definitions

Prior to discussing the present invention in further details, the following terms and conditions will first be defined:

In the context of the present invention, mentioned percentages are weight/weight percentages unless otherwise stated.

The term “and/or” used in the context of the “X and/or Y” should be interpreted as “X”, or “Y”, or “X and Y”.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 1 to 8, from 3 to 7, from 4 to 9, from 3.6 to 4.6, from 3.5 to 9.9, and so forth. All references to singular characteristics or limitations of the present invention shall include the corresponding plural characteristic or limitation, and vice versa, unless otherwise specified or clearly implied to the contrary by the context in which the reference is made.

Unless defined otherwise, all technical and scientific terms used herein have the same meaning as commonly understood by one of ordinary skill in the art.

As used in this specification, the words “comprises”, “comprising”, and similar words, are not to be interpreted in an exclusive or exhaustive sense. In other words, they are intended to mean “including, but not limited to”.

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

### Structuring Agents

In a preferred embodiment of the invention it relates to a lipid composition comprising between 5 and 50 wt % of a structuring agent dispersed in between 50 and 95 wt % edible fat/oil wherein the structuring agent comprises at least 50 wt % of triacylglycerol containing a glycerin skeleton esterified with one type of saturated fatty acid having a chain length of either 10:0, 12:0 or 14:0. It is preferred that the triacylglycerol containing a glycerin skeleton esterified with one type of saturated fatty acid is a symmetric triacylglycerol containing a glycerin skeleton esterified exclusively with one type of saturated fatty acid.

Structuring agents are materials which, when added to another material, create or enhance a structure within the material. Structuring agents may act by creating a framework within a material, so altering the material's physical properties, for example by making the material more rigid.

Without wishing to be bound by theory or hypothesis, it is believed that the following solidification mechanism occurs: the structuring agent represents a lipid substance that is very different in terms of polarity and size from the liquid oil e.g. high oleic sunflower oil. Due to this difference, the formation of the otherwise commonly observed eutectic mixture (e.g. coconut oil and high oleic sunflower mixture) is minimal leading to strong separation and crystallization of the structuring agent upon cooling. The structuring agent might crystalize into beta plate-like crystals as described in J. Am. Oil Chem. Soc. 71:1367-1372 (1994). These crystals will form a conjugated microstructure within the lipid blend that will not act as a classic, macroscopic elastic gel, but will be sufficient to immobilize the liquid oil. The separated structuring agent crystals and the immobilized liquid oil remain then separated in solid and liquid forms respectively even at room temperature, explaining the stability of the solidified mixture at room temperature.

In the present invention, the term fat refers to lipidic solids, semisolids or liquids that are water-insoluble esters of glycerol with fatty acids. Fats are the chief component of animal adipose tissue and many plant seeds.

Triacylglycerol, sometimes called triglyceride, is an ester derived from glycerol and three fatty acids. It is a lipid molecule consisting of a glycerol residue connected by ester linkages to three fatty acid residues. The triacylglycerol used in the invention is symmetric triacylglycerol containing a glycerin skeleton esterified exclusively with one type of saturated fatty acid having a chain length of either 10:0, 12:0 or 14:0. Hundreds of other, diverse types of triglycerides occur in nature, depending on the oil source, some are highly unsaturated, some less so.

Generic chemical structure of the structuring agent family: The group “R” is an alkyl group that represents the saturated chain moiety of the C10:0, C12:0 or C14:0 fatty acids respectively.

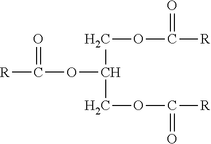

It is an advantage that the lipid composition of the invention may provide many of the physical attributes of hard fats, such as not flowing under gravity, without containing trans-unsaturated fatty acids or high levels of saturated fatty acids. The lipid composition of the invention may be free of trans-unsaturated fatty acids. As the structuring agent used in the invention itself comprises saturated fatty acids it is advantageous that it may be added at low levels. The lipid composition may comprise between 5 and 50 wt. % structuring agent, preferably between 10 and 45 wt. %, more preferably between 15 and 40 wt. %. The lipid composition according to the invention may have less than 60 wt. % saturated fatty acids, preferably less than 50 wt. % saturated fatty acids, more preferably less than 40 wt. % saturated fatty acids, even more preferably less than 30 wt. % saturated fatty acids. The wt. % of saturated fatty acids is calculated as the percentage weight of saturated fatty acids, whether esterified to glycerol molecules or as free fatty acids, in the total weight of the lipid composition. Typically this is analysed by converting the lipid composition to fatty acid methyl esters and quantifying them using chromatography. Such determinations are routinely performed in oils and fats laboratories [W. W. Christie, Gas Chromatography and Lipids—A Practical Guide, The Oily Press, Dundee, UK. (1989)].

The higher the content of symmetric triacylglycerol having a glycerin skeleton esterified exclusively with one type of saturated fatty acid having a chain length of either 10:0, 12:0 or 14:0 in the structuring agent, the more effective it is, and the less structuring agent need to be dispersed in the lipid edible fat to achieve the same effect. The lipid composition of the present invention may comprise at least 5 wt. % of symmetric triacylglycerol having a glycerin skeleton esterified exclusively with one type of fatty acid having a chain length of either 10:0, 12:0 or 14:0, preferably it may comprise at least 10 wt. % of symmetric triacylglycerol having a glycerin skeleton esterified exclusively with one type of saturated fatty acid having a chain length of either 10:0, 12:0 or 14:0.

The structuring agent may comprise at least 50 wt. % of symmetric triacylglycerol having a glycerin skeleton esterified exclusively with one type of saturated fatty acid having a chain length of either 10:0, 12:0 or 14:0, preferably it may comprise at least 50 wt. % of symmetric triacylglycerol having a glycerin skeleton esterified exclusively with one type of saturated fatty acid having a chain length of either 10:0, 12:0 or 14:0, more preferably it may comprise at least 95 wt. % of symmetric triacylglycerol having a glycerin skeleton esterified exclusively with one type of saturated fatty acid having a chain length of either 10:0, 12:0 or 14:0.

### Edible Fat

The edible fat used in the present invention may have a solid fat content higher than 50% at 20° C. For example the edible fat may be a fat suitable for forming a coating, such as an ice cream coating or confectionery coating. Solid fat contents may be measured by pulse NMR, for example according to the IUPAC Method 2.150. The edible fat may be selected from the group consisting of palm oil, palm kernel oil, coconut oil, cocoa butter, illipe, sal, shea, their hydrogenated derivatives and combinations of these. The structuring agent of the present invention may advantageously be added to alter the texture of an edible fat, for example an edible fat having a solid fat content higher than 50% at 20° C. The structuring agent of the invention may provide resistance to deformation when products comprising the lipid composition are exposed to temperature 30° C. or above, or it may provide an improved snap for products comprising the lipid composition having a solid fat content higher than 50% at 20° C., for example a chocolate-like material. Snap is the desirable textural property of chocolate-like materials which causes them to break cleanly, often with a distinctive noise, when bent in the hands or bitten into.

### Liquid Oil

The edible fat used in the present invention may be a liquid oil. In the context of the present invention, the term liquid oil refers to fats which are essentially liquid at room temperature, for example having less than 3% solid fat content at 20° C. It is advantageous to be able to structure liquid oils. Monounsaturated and polyunsaturated fats are liquid at room temperature. Both of these types of fats can be beneficial in the diet, for example reducing blood cholesterol, which can decrease the risk of heart disease. By structuring these liquid oils they can be used to replace less healthy harder fats in a number of applications. The structuring agent may transform aliquid oil, altering its physical properties such that its fluidity will decrease and its rheological properties will be similar to those of harder fats.

The liquid oil of the present invention may be any commercial vegetable or animal oil. The liquid oil may be selected from the group consisting of sunflower oil, soybean oil, safflower oil, corn oil, olive oil, canola oil, palm oil, fish oil, their respective high-oleic variants and the combinations of these. The liquid oil may be a high oleic vegetable oil, including specifically tailored algal or fungal oils. High oleic oils are those having over 70% of their fatty acids as oleic acid. Oleic acid is a common monounsaturated fat in human diet. Monounsaturated fat consumption has been associated with decreased low-density lipoprotein cholesterol.

### Lipid Composition

The lipid composition of the invention may be a paste like solidified fat or/and organogel. Organogels are bi-continuous colloidal systems that co-exist as a micro heterogeneous solid and organic liquid phase. Surprisingly, the inventors found that the lipid composition of the invention may form such an organogel, the structuring agent being the micro heterogeneous solid and liquid oil being the organic liquid phase. The rheology of the liquid oil, which has a low viscosity and no elasticity, is transformed by the formation of the organogel, so that the resulting lipid composition resembles a solid fat, having a semi-solid paste character and/or being elasto-plastic. Edible lipid oil organogels are sometimes called oleogels.

The lipid composition of the invention may be used as a moisture barrier in a food product. Moisture migration is a problem in many food products, for example when there are regions in the product which are high in moisture and others which are dryer. Moisture will tend to equilibrate throughout the product. Specifically, moisture migrates until the water activity (A_{w}) of the different components is the same. Water activity is a measure of the amount of unbound water available. Moisture migration can have a deleterious effect on a product over its shelf-life. One method to prevent or delay moisture migration is to add a moisture barrier between the components having different water activity (A_{w}). Fats are hydrophobic and so provide a suitable material for a moisture barrier. Hard fats are typically used as moisture barriers, as they are less likely to be physically displaced within the food product and they adhere well to surfaces, for example to form a moisture barrier inside a wafer ice cream cone. Unfortunately many hard fats have the dietary disadvantages discussed above, such as high levels of saturated fatty acids. It is advantageous that the lipid composition of the invention may be used to form a moisture barrier, providing a more healthy dietary material. The edible lipid compositions of the present invention have a further advantage when used as a moisture barrier. Hard fats are brittle, and so when they are used as a moisture barrier they may develop cracks. Once a moisture barrier has a crack, moisture can penetrate through the crack and the effectiveness of the moisture barrier is greatly reduced, or even completely lost. The semi-solid fats/organogels of the present invention have a continuous liquid oil phase which acts as an effective moisture barrier. Since these lipid compositions also have a solid-like structure they are not easily physically displaced within the food product. Furthermore, unlike hard fats the present lipid compositions are not brittle and do not crack, which makes them more effective as moisture barriers.

The lipid composition of the invention may be used as a structure stabilizer in a food product. The lipid composition after melting remains liquid at room temperature and solidifies into an organogel/paste when cooling to 4° C. or below and remains in this solidified state when bringing back to room temperature. The lipid composition of the invention might be used to replace some or all of the hard fats with high saturated fatty acid levels in ice cream bulk or coatings which helps to reduce saturated fatty acid levels while creating the desired smooth and creamy texture.

### Food Products

The lipid composition of the invention may advantageously be used in food products, for example as a replacement for fats high in saturated fatty acids. A further embodiment of the invention may be a food product comprising the lipid composition. The food products may be frozen confectionery products, confectionery products, culinary products or dairy products.

The food product may be a frozen confectionery product for example with the lipid composition replacing some or all of the hard fats in an ice cream based on vegetable fats. The lipid composition may be used within the bulk phase of the ice-cream, the fat-based coating on a stick, or the lipid composition may be used as a moisture barrier inside/on an ice-cream wafer cone.

In the context of the present invention the term “frozen confectionery product” means a confectionery product comprising ice crystals distributed throughout a sweetened and/or flavoured aqueous product and typically having a refreshing and cooling effect with a nice appearance.

Frozen confectionery products include water in the form of ice crystals and are for consumption in a frozen or semi-frozen state, i.e. under conditions wherein the temperature of the product is less than 0° C., and preferably under conditions wherein the product comprises a significant amount of ice crystals.

Frozen confectionery products may also be called “frozen confectioneries”, “frozen confections”, “ice desserts” or “frozen desserts” and these terms may be used interchangeably.

In an embodiment of the invention the frozen confectionery product is an aerated frozen confectionery product.

By the term “frozen aerated confectionery product” is meant any aerated frozen dessert.

In the context of the present invention, the term “aerated” relates to a product which have air cells distributed throughout the product. The air cells or air bubbles can be distributed throughout the product for example by extrusion or whipping air into the product. For example, one volume part of air whipped into one volume part of ice cream mix is equal to 100% overrun, as described in Ice Cream, 6th Edition, Robert T Marshall, H. Douglas Goff and Richard W Hartel (2003), Kluwer Academic/Plenum Publishers.

In an embodiment of the present invention, the product has an overrun of at least 20%, such as in the range of 20-150%, preferably in the range of 80-130%, even more preferably in the range of 100-130%.

Overrun relates to the amount of air whipped in to an ingredient mix for preparing aerated products. Overrun is a term generally recognized for the skilled person within the field of ice cream production and in the present invention overrun is defined as the increase in volume, in percentage, of ice cream greater than the volume of the mix used to produce that ice cream. In other words, if you start off with 1 litre of mix and you make 2.0 litres of ice cream from that, you have increased the volume by 100% (i.e., the overrun is 100%).

In an embodiment of the invention, the frozen confectionery product may be selected from the group of frozen dairy dessert, cultured frozen dairy dessert, ice cream, low-fat ice cream, frozen yoghurt, milk shake, milk ice. In a preferred embodiment, the frozen confectionery product is an ice cream, which may be a full fat ice cream or low fat ice cream.

In an embodiment of the invention, the frozen confectionery product comprises from 0.5% to 20% fat by weight. In another embodiment of the invention, the frozen confection product is a low-fat product and comprises at most 6% fat by weight.

Confectionery products include biscuits; cakes; pastries; sugar confectionery, such as toffees; and fat-based confectionery products. Fat-based confectionery products should be understood as referring to products comprising dark, milk or white chocolate; or to chocolate analogues containing milk fat, milk fat replacers, cocoa butter replacers, cocoa butter substitutes, cocoa butter equivalents, non metabolizable fats or any mixture thereof; or Caramac™ sold by Nestlé comprising non-cocoa butter fats, sugar and milk; nut pastes such as peanut butter and fat; and/or praline among others. Fat-based confectionery products may include sugar, milk derived components, and fat and solids from vegetable or cocoa sources, or any other usual ingredient for chocolate such as lecithin for example, in different proportions. The lipid composition of the invention may be comprised within fillings, for example fillings inside a hollow fat-based confectionery shell, extruded fillings, or fillings between biscuits.

The food product of the invention may be a culinary product. Culinary products are food compositions typically prepared or used in kitchens. The lipid composition may for example be used to replace fats in the formulation of creamy soups, fillings or surface coatings, soft concentrated bouillons or hard concentrated bouillons, e.g. bouillon cubes. The solid-like rheology of the lipid composition helps to keep the ingredients of the bouillon cube together, but without the high saturated fat acid content of conventional hard fats.

The food product of the invention may be a dairy product, for example a cheese spread, or the lipid composition of the invention may be used to coat inclusions such as cereals, dried fruit or nuts which are dispersed in yoghurt, the lipid composition acting as a moisture barrier and preventing the inclusions from becoming soft too quickly.

### Method

A further aspect of the current invention is a method for preparing the lipid composition of the invention comprising preparing a structuring agent comprising at least 50 wt % of triacylglycerol having a glycerin skeleton esterified with one type of saturated fatty acid having a chain length of either 10:0, 12:0 or 14:0; melting the structuring agent; combining the structuring agent with an edible fat to form a mixture; homogenizing the mixture; and cooling the mixture to 4° C. or below. The mixture may for example be cooled to a temperature below the melting point of the structuring agent. Homogenization may be carried out by any of the methods commonly used in the food industry, for example a high shear mixer may be used, or the edible fat and molten structuring agent may be passed through a static mixer. The structuring agent and edible fat may further be mixed with other ingredients, for example sugar, cocoa powder, milk powder, flavorings and colors. Cooling may take place after incorporation of the structuring agent and edible fat mixture into another product, for example the mixture ice cream ingredients to form a structure stabilizer and then cooled.

The structuring agent may be prepared by chemical or enzymatic esterification, enzymatic interesterification, fractionation process or the combination thereof. The structuring agent comprises at least 50 wt % of symmetric triacylglycerol containing a glycerin skeleton esterified exclusively with one type of saturated fatty acid having a chain length of either 10:0, 12:0 or 14:0

In the context of the present invention the term esterification includes the reaction of glycerol or a partial glyceride with a fatty acid. The interesterification may use any of the techniques known in the art. For example the interesterification process may be a random interesterification with an alkaline catalyst or a lipase catalyst. The interesterification may be a directed interesterification where the interesterification is directed towards particular positions on the glycerol moiety. Fractionation may be carried out via crystallization of solvent assisted fractionation either on the free fatty acid substituents or on the esterified triacylglycerols or both.

Those skilled in the art will understand that they can freely combine all features of the present invention disclosed herein. In particular, features described for the product of the present invention may be combined with the method of the present invention and vice versa. Further, features described for different embodiments of the present invention may be combined. Where known equivalents exist to specific features, such equivalents are incorporated as if specifically referred to in this specification. Further advantages and features of the present invention are apparent from the figures and non-limiting examples.

### Method:

### Mass Spectrometry

An LTQ-Orbitrap XL hybrid mass spectrometer (Thermo-Fisher Scientific, Bremen, Germany) equipped with an Electrospray ionization (ESI) source was used. Analysis of tri- and diacylglcyerols was performed in the linear ion trap operated in positive ion mode. ESI nebulizer probe was maintained at 150° C., capillary voltage was 5 kV. Nebulizer and auxiliary gas flows were nitrogen at 40 and 20 units, respectively. Tube lens was adjusted to 60 V, other parameters were the typical values optimized during calibration. The linear ion trap operated at unit mass resolution in an m/z 100-2,000 range. From the generated molecular ions only the ammoniated adducts were fragmented. Accumulation time was 50 ms, normalized collision energy was 25%, activation Q value was 0.250, activation time was 30 ms.

For analysis, 10 μL sample was first dissolved in 1 mL acetone. Then, 10 μL of this latter solution was further diluted in 1 mL buffer mix of 1 mM ammonium-formate and 2 μM sodium-formate solubilized in methanol. The resulting sample solution was infused at 10 μL/min flow rate into the mass spectrometer for analysis.

### EXAMPLES

### Example 1

### Production of Structuring Agent Trialurin

### Esterification

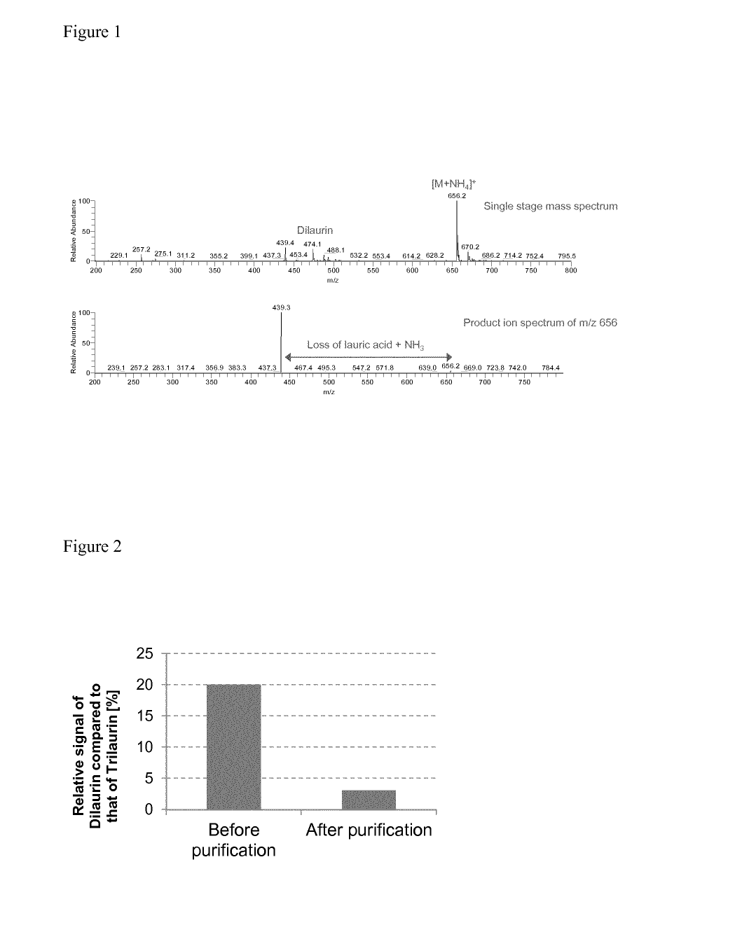

Lauric acid and glycerol were mixed in a relative proportion of 3.3:1 corresponding to the theoretical reaction stoichiometry of the desired final triacylglycerol (TAG) plus 10% lauric acid excess. 1% sodium methanolate was added as base and the reaction was carried out at 200° C. for 2 h to ensure equilibrium. Single and tandem stage mass spectrometric characterization (for details see below) of this reaction mixture confirmed the formation of trilaurin: FIG. 1 depicts the observed pseudomoelcular ion with m/z 656. Note, that signals corresponding to the residual amount of dilaurin are also present in the single stage spectrum. FIG. 1 also shows the fragmentation pattern of parent ion m/z 656 reflecting the loss of lauric acid—bottom part. (FIG. 1.)

### Purification of Structuring Agent

The reaction mixture was purified to remove the base and eliminate the residual dilaurin. 10 mL reaction mixture was subjected to liquid-liquid extraction using 400 mL methanol:isooctane at a ratio of 1:1. The separated isooctane phase was again subjected to LLE four times. The final isooctane phase was dried at 85° C. under successively increased vacuum until 30 mbar. The observed single stage mass spectrum of the purified structuring agent confirmed the elimination of dilaurin, see FIG. 2.

### Example 2

### Preparation of a Structured Lipid Composition

The structuring agent prepared in Example 1 was melted at 60° C., then added at a level of 20% by weight to a likewise at 60° C. liquid oil, the oil being a high oleic sunflower oil. The high oleic sunflower oil had a saturated fatty acid content of 8% as determined by the classical transmethylation gas-chromatpgraphy method [W. W. Christie, Gas Chromatography and Lipids—A Practical Guide, The Oily Press, Dundee, UK. (1989)]. The oil and structuring agent were homogenized by briefly vortexing the mixture. This mixture was liquid and remained for hours liquid at room temperature. The mixture solidified within an hour when cooled to 4° C. and retained its gel structure when brought back to room temperature. This lipid composition contained 20% of structuring agent and had a total saturated fatty acid content of 28%.

### Example 3

### Solidification Comparison of a Structured Lipid Composition

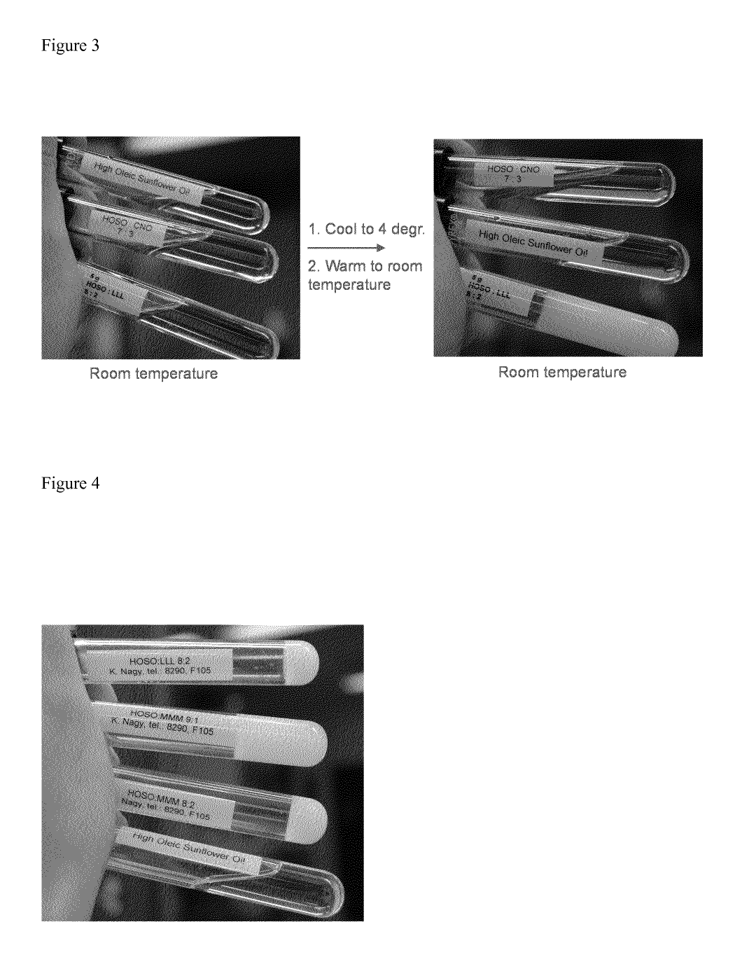

The lipid composition prepared in Example 2 was compared to pure high oleic sunflower oil (saturated fatty acid content of 8%) and a mixture of high oleic sunflower oil and coconut oil 7:3 (saturated fatty acid content of 33%). All mixtures were first melted at 60° C., cooled to 4° C. and then let stand at room temperature for a day. FIG. 3 shows that high oleic sunflower oil and the mixture of high oleic sunflower oil and coconut oil 7:3 appeared completely liquid. The lipid composition prepared in Example 2 remained solidified despite the fact that its saturated fatty acid content was lower than that of the mixture of high oleic sunflower oil and coconut oil 7:3. (FIG. 3.)

### Example 4

### Solidification Comparison of Various Structured Lipid Compositions

The lipid composition prepared in Example 2 was compared to pure high oleic sunflower oil (saturated fatty acid content of 8%), a mixture of high oleic sunflower oil:trimyristin 9:1 and a mixture of high oleic sunflower oil:trimyristin 8:2. All mixture were first melted at 60° C., cooled to 4° C. and then let stand at room temperature for a day. (FIG. 4.) The lipid composition prepared in Example 2 and the mixture of high oleic sunflower oil:trimyristin 9:1 and the mixture of high oleic sunflower oil:trimyristin 8:2 remained solidified at room temperature while pure high oleic sunflower oil remained liquid.

### Example 5

### Structuring of High Oleic Sunflower Oil Using Chemical Grade Commercially Available 15% Trilaurin Structuring Agent

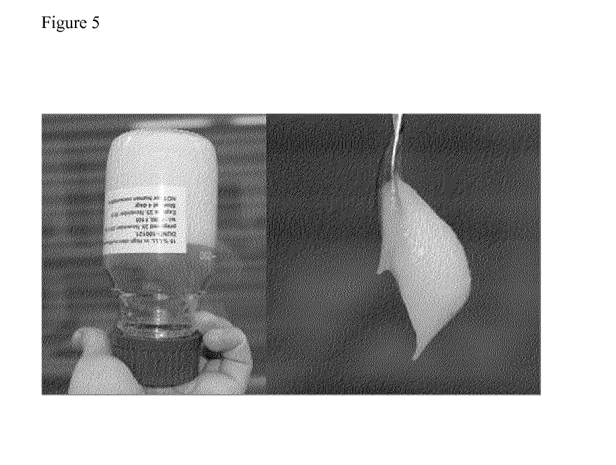

This example demonstrates similar solidification effect using a different source of trialurin (VWR International AG, Dietikon, Switzerland). High oleic sunflower oil and trilaurin were melted at 60° C., mixed in a 15:85 proportion, cooled to 4° C. and then let stand at room temperature for a day. The obtained lipid blend displayed the expected solidification, as shown in FIG. 5.

1. A lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0.

2. A lipid composition according to claim 1, comprising between 5 to 50 wt % of the structure agent dispersed in between 50 and 95 wt % oil or fat.

3. The lipid composition according to claim 1, wherein the structuring agent is produced by a process selected from the group consisting of chemical or enzymatic esterification, enzymatic interesterification, fractionation process and combinations thereof.

4. A lipid composition according to claim 1, wherein the liquid oil is selected from the group consisting of sunflower oil, soybean oil, safflower oil, corn oil, olive oil, canola oil, palm oil, their respective high-oleic variants and the combinations of these.

5. The lipid composition according to claim 1, wherein the lipid composition has less than 60 wt % saturated fatty acids.

6. A lipid composition according to claim 1, wherein the lipid composition after melting remains liquid at room temperature and solidifies into an paste and/or organogel when cooling to 4° C. or below and remains in this solidified state when bringing back to room temperature.

7. A structuring agent comprises at least 50 wt % of triacylglycerol containing a glycerin skeleton esterified with one type of saturated fatty acid having a chain length of either 10:0, 12:0 or 14:0.

8. A method for stabilizing a food product comprising adding a lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0 to the food product.

9. A method for providing a moisture barrier in a food product comprising adding a lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0 to the food product.

10. Food product comprising a lipid composition comprising at least 5 wt % of a structuring agent dispersed in oil or fat wherein the structuring agent comprises at least 50 wt % of triacylglycerol containing a glycerin skeleton esterified with one type of saturated fatty acid having a chain length of either 10:0, 12:0 or 14:0.

11. Food product according to claim 10 wherein the food product is selected from the group consisting of a frozen confectionery product, a confectionery product, a culinary product and a dairy product.

12. Method for preparing the lipid composition comprising
preparing a structuring agent comprising at least 50 wt % of triacylglycerol containing a glycerin skeleton esterified with one type of saturated fatty acid having a chain length of either 10:0, 12:0 or 14:0;
melting the structuring agent;
combining the structuring agent with an edible fat to form a mixture;
homogenizing the mixture; and
cooling the mixture to 4° C. or less.
